(19) United States
(12) Patent Application Publication
(10) Pub. No.: US 2023/0061996 A1
(43) Pub. Date: Mar. 2, 2023

(54) OIL FILTER ASSEMBLY

(71) Applicant: RB Distribution, Inc., Colmar, PA (US)

(72) Inventors: Andrew Setz KELLY, Philadelphia, PA (US); evan SODA, Perkiomenville, PA (US); Gabriel KOVACS, Abington, PA (US); Robert PISCH, Willow Grove, PA (US); Eric TRYSON, Willow Grove, PA (US)

(73) Assignee: RB Distribution, Inc., Colmar, PA (US)

(21) Appl. No.: 17/985,565

(22) Filed: Nov. 11, 2022

Related U.S. Application Data
(63) Continuation of application No. 17/528,884, filed on Nov. 17, 2021.
Application No. 17/528,884 is a continuation of application No. 17/406,639, filed on Aug. 19, 2021.
(60) Provisional application No. 63/068,759, filed on Aug. 21, 2020.

(51) Int. Cl. F01M 11/03

(52) U.S. Cl. CPC F01M 11/03; F01M 2011/033

(57) ABSTRACT

A one-piece cast metallic adaptor for an engine lubrication system that has threading in the casting to secure components to the one-piece cast metallic adaptor.

### CROSS REFERENCE TO RELATED APPLICATION

This application is a Continuation of U.S. application Ser. No. 17/528,884, which was filed on Nov. 17, 2021 as a Continuation of U.S. application Ser. No. 17/406,639, which was filed on Aug. 19, 2021 and claimed the benefit of U.S. Provisional Application No. 63/068,759, filed on Aug. 21, 2020, each of which is incorporated herein by reference as if fully set forth.

### FIELD OF INVENTION

The invention relates generally to the lubrication of mechanical engines that utilize oil as a lubricating fluid that circulates though defined galleries in the engine. More particularly, the invention relates to a lubrication system where the lubricating fluid is routinely passed through a filter element, which is generally replaceable at certain intervals, and potentially and oil cooler. Most particularly, the invention relates to an adaptor for a lubrication system that incorporates the oil filter housing and an oil cooler in an assembly that is often located within the motor valley.

### BACKGROUND

Modern engines, especially though used in motor vehicles, seek to reduce weight and size while maintaining the desired power. As part of the effort to reduce weight, many parts are being made in plastic and many parts are being combined in assemblies to further reduce weight by eliminating individual connection points. While this trend has proven successful in some areas, it has introduced problems where one or more portions of a plastic assembly experience a failure. Under these conditions, it is often necessary to disassemble unrelated parts of the engine in order to gain access to the assembly and make the necessary repairs.

Another drawback to plastic assemblies is the need to made accommodations for various sensors and system components that need to be connected to the assembly. These connections are most often achieved by molding an opening in the plastic component and attaching a metallic insert to achieve the connection. This plastic to metal connection can be difficult to properly seal. An addition failure point of this metal-plastic connector is the possibility of over tightening the inserted component, such as a sensor fitting or cap, and stressing or damaging the surrounding plastic.

In addition to the above associated with a hybrid plastic-metallic assembly, the molding process requires certain concessions in order to permit molding cores to be inserted and removed during the molding process. An associated drawback with the plastic molding is the need to remove core elements used in the process and reseal the molding which leads to further potential failure points. In addition, the unused molded openings that require closing plugs that must be glued or welded in the unused openings. These plugs represent another failure point in the plastic-metallic assembly.

### SUMMARY

The applicants have discovered that a cast metallic part provides a robust assembly that avoids the needs for inserts, eliminates the need for plugs, and provides for direct threading of components to the adaptor. As a result of eliminating the assembly of multiple molded parts, the performance and durability is improved against burst pressure, heat and age degradation, and conditions related to cycling. In addition, the single metallic casting provides a flow path without the need for adhesives and resealing of the flow path.

### BRIEF DESCRIPTION OF THE DRAWINGS

FIG. 1 is a perspective view of a prior art oil filter adaptor and cooler assembly;

FIG. 2 is a partial rear view of the prior art assembly in FIG. 1;

FIG. 3A illustrates the capping of the oil flow path in the prior art adaptor after removal of the core used in the plastic molding;

FIG. 3B is a section illustrating the flow path in the prior art adaptor;

FIG. 4 is a perspective view of an adaptor according to the invention prior to assembly of any related components;

FIG. 5 is a section view along the line 5-5 in FIG. 4 showing the linear flow path in an adaptor according to the invention; and,

FIG. 6 is a perspective view of an adaptor according to the invention in a direction opposite to that of FIG. 4.

### DETAILED DESCRIPTION OF THE PREFERRED EMBODIMENTS

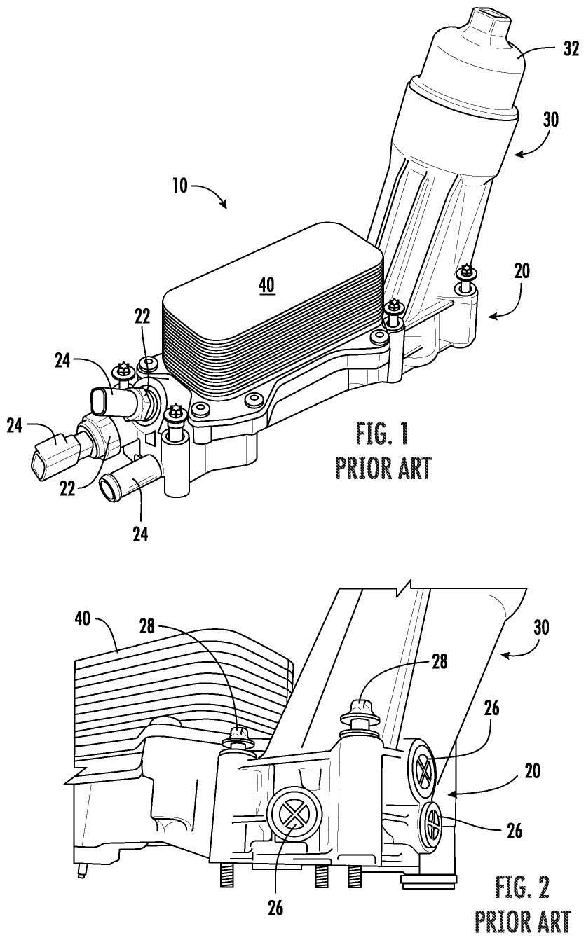

The prior art oil filter assembly shown in FIGS. 1-3B is typical of the adaptor construction resulting from using moldable plastic materials. The prior art assembly 10 in FIG. 1 has a base 20, a filter housing 30 and an oil cooler 40. The base 20 includes medal inserts 22 that are provided in the plastic construction at designated locations for the attachment of other associated components. The metal inserts and associated components are shown in FIGS. 1 at 22 and 24 respectively. Although the metal inserts are frequently molded in situ during the molding of the plastic base, they remain a failure point and can result in oil leakage or worse. The metal inserts 22 are also subject to overtightening during attachment of the associated components 24, which can result in stress cracks in the plastic.

As shown in FIG. 2, the base 20, due to the molding process requiring the ability to withdrawal a core, has a number of plugs 26 that are retrofitted after the base 20 is molded. The plugs 26 are assembled to the molded base with an adhesive or spin welding. In either event, the plugs 26 are a failure point in the base 20 that can result in oil leaking or worse.

In addition to the inserts 22 and plugs 26, the base 20 has a number of metal inserts or sleeves, not shown, that are inserted to reinforce the plastic molded apertures for attachment of the various bolts 28 that hold the assembly 10 together. Here again, the inserts or sleeves introduce a potential failure point. Another potential failure point is the attachment of the cap 32 to the plastic filter housing 30. Over tightening of the cap 32 can introduce stress fracture in the threaded housing 30.

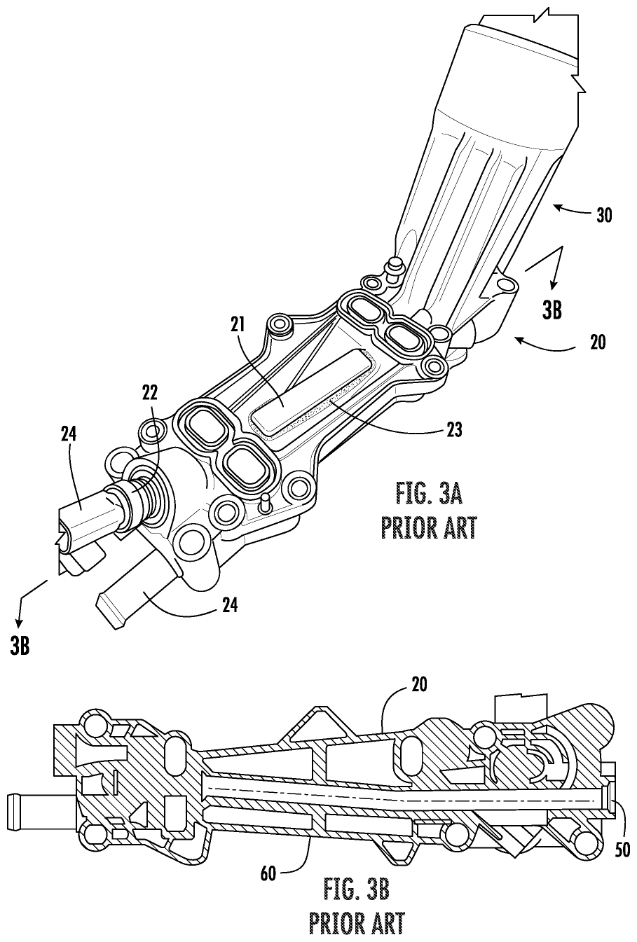

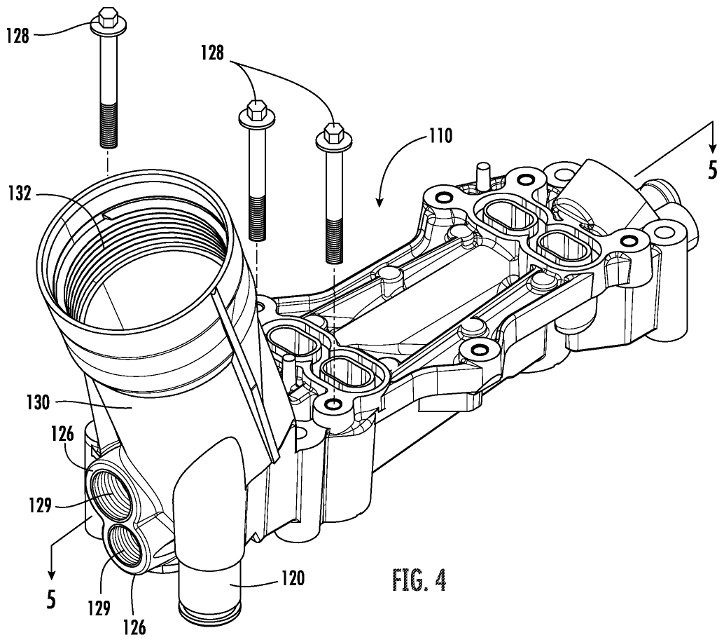

With reference to FIGS. 3A and 3B, it can be seen that the prior art flow path 50 requires a cover 21, at least partially over the flow path, that is adhered to the base after the molding core is removed by the adhesive or welding 23. With reference to FIG. 4B, it can be seen that the flow path 50 bends or is angular; in other word, the flow path 50 does not have a common longitudinal axis.

With reference to FIG. 4, the preferred adaptor 110 has a filter housing 130 and base 120 that is formed of a casted metallic material, preferably aluminum. The base 120 and the filter housing 130 are casted together and the apertures 127 for receiving the bolts 128 do not required metal inserts or sleeves to avoid stressing or cracking do to the solid metallic construction. The casting is also threaded at 129 to receive fasteners for securing an oil cooler 40 to the adaptor 110.

Still with reference to FIG. 4, the casted filter housing 130 has internal threaded 132 that mate with an OEM cap 32 to secure a filter within housing 130. In a similar manner, the apertures 126 have internal threading to preferably mate with NPT plugs that are self-sealing. Depending on the type and construction of related components, such as sensors, it may be necessary to employ a gasket or sealing rings with their assembly.

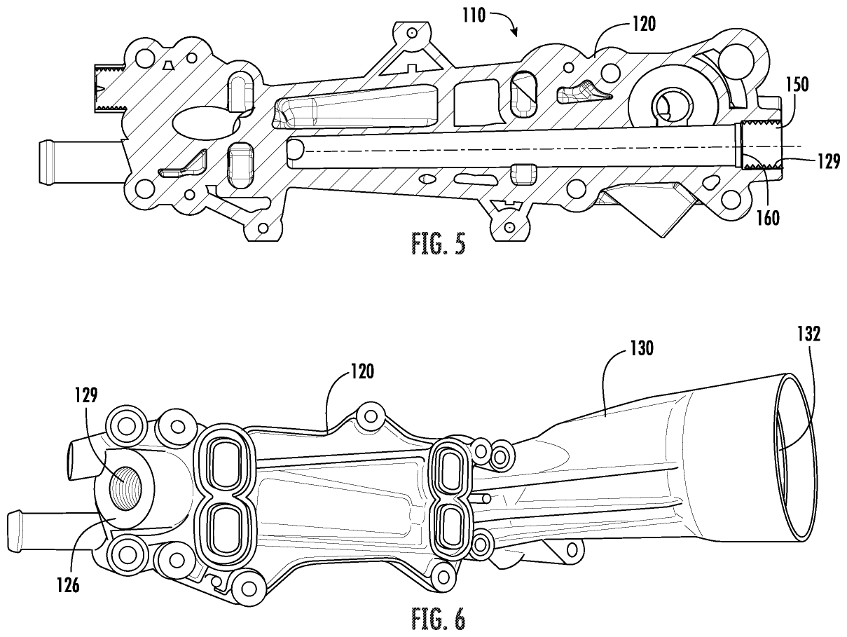

With reference to FIG. 5, the flow path 150 for transporting the lubricant in base 120 is centered about the longitudinal axis 160 and consistent throughout the base 120. The flow path 150 is symmetric about the axis 160 and there is no angular component in the flow path 150. The flow path 150 is entirely within the unitary casting so there is no need for adding a closure to the flow path.

With the exception of the flow path 150, the lubrication galleries and the location positions for associated components are identical to the OEM assembly so the casted metal adaptor is a direct replacement for the OEM part and no modifications or relocations of other components are necessary.

As shown in FIGS. 4 and 6, the adaptor 110, including the filter housing 130 and the base 120 outwardly appearance the same as the OEM part and the base accepts the OEM cooler 40 and the filter housing accepts the cap 32 without any modification.

What is claimed is:

1. An engine oil adaptor comprising:
a metallic casting having:
an elongated body portion with; a lower surface configured to mate with a lubrication network in an engine; an upper surface configured to mate with a cooling component; an oil filter housing defined at a first end of the elongated body; and, a lubrication flow path that establishes a communication channel between the lubrication network and the filter housing;
wherein the body includes a plurality of casted apertures that are threaded for mating with a respective threaded component.

2. The adaptor of claim 1, wherein the elongated cast metallic body includes a plurality of threaded casted apertures for receiving threaded fasteners that secure the cooling component to the elongated cast metallic body.

3. The adaptor of claim 1, wherein the lubrication flow path is parallel to a longitudinal axis through the lower surface of the elongated body.

4. The adaptor of claim 1, wherein the upper surface has a plurality of casted apertures that are threaded for receiving threaded fasteners that secure the cooling component to the upper surface.

5. The adaptor of claim 1, wherein the oil filter housing has an open end that is internally threaded to receive a threaded closure.

6. The adaptor of claim 1, wherein at least one of the plurality of casted apertures is positioned at a first end of the elongated body and at least one of the plurality of casted apertures is positioned at a second end of the elongated body.

7. An adaptor for an engine oil filtering system comprising:
a metallic casting having:
an elongated body portion with; a lower surface configured to mate with a lubrication network in an engine; an upper surface configured to mate with an oil cooler; an oil filter housing extending from the elongated body; and, a lubrication flow path that establishes a communication channel between the lubrication network and the filter housing;
wherein the elongated body includes a plurality of casted through passages defining the lubrication flow path and a plurality of casted apertures that are threaded for mating with a respective threaded member.

8. The adaptor of claim 7 wherein the lubrication flow path is parallel to a longitudinal axis through the lower surface of the elongated body.

9. The adaptor of claim 7 wherein the elongated cast metallic body includes a plurality of threaded casted apertures for receiving threaded fasteners that secure the oil cooler to the elongated cast metallic body.

10. The adaptor of claim 7 wherein the upper surface has a plurality of threaded casted apertures that are located to receive threaded fasteners that secure the oil cooler to the upper surface.

11. The adaptor of claim 7, wherein the oil filter housing has an open end that is internally threaded to receive a threaded closure.

12. The adaptor of claim 7, wherein at least one of the plurality of casted apertures is positioned at a first end of the elongated body and at least one of the plurality of casted apertures is positioned at a second end of the elongated body.

13. An adaptor for connecting an oil filter to an engine lubrication system, the adaptor comprising:
a one-piece metallic casting having: an elongated body portion with; a lower surface configured to mate with an engine having a lubrication network; an integrally casted oil filter housing extending from an upper surface at a first end of the elongated body; and, a fluid passage that extends through the elongated body portion and establishes a flow path between the lubrication network and the filter housing;
wherein the elongated body includes a plurality of casted apertures that are threaded for mating with a respective threaded component.

14. The adaptor of claim 13 wherein the fluid passage mirrors a longitudinal axis through the lower surface of the elongated body.

15. The adaptor of claim 13 wherein the elongated body has an upper surface with least two of the plurality of threaded casted apertures that are located to receive threaded fasteners that secure an oil cooler to the elongated cast metallic body.

16. The adaptor of claim 13, wherein the oil filter housing has an open end that is internally threaded to receive a threaded closure.

17. The adaptor of claim 13, wherein at least one of the plurality of casted apertures is positioned at the first end of the elongated body and at least one of the plurality of casted apertures is positioned at a second end of the elongated body.
